(19) United States
(12) Patent Application Publication
(10) Pub. No.: US 2018/0009714 A1
(43) Pub. Date: Jan. 11, 2018

(54) METHOD OF PRODUCING DIELECTRIC MATERIAL

(71) Applicant: Murata Manufacturing Co., Ltd., Nagaokakyo-shi (JP)

(72) Inventors: Kazuhiko Higashide, Nagaokakyo-shi (JP); Shinya Konishi, Nagaokakyo-shi (JP); Shuya Nakao, Nagaokakyo-shi (JP)

(21) Appl. No.: 15/712,587

(22) Filed: Sep. 22, 2017

Related U.S. Application Data
(63) Continuation of application No. PCT/JP2016/051857, filed on Jan. 22, 2016.

(30) Foreign Application Priority Data
Mar. 27, 2015 (JP) 2015-067164

(51) Int. Cl. C04B 35/468; C04B 35/626; H01G 4/12; C07F 7/04; C04B 35/47

(52) U.S. Cl. CPC C04B 35/4682; H01G 4/12; C07F 7/04; C04B 35/6264; C04B 35/47; C01P 2006/16

(57) ABSTRACT

A method of producing a dielectric material by preparing a slurry by mixing a dielectric powder, water, one of an organic-acid metal salt and an inorganic metal salt, and an organic silicon compound, causing the slurry to come into contact with an anion exchange resin to remove an anion derived from the one of the organic-acid metal salt and the inorganic metal salt from the slurry, and drying the slurry to obtain the dielectric material.

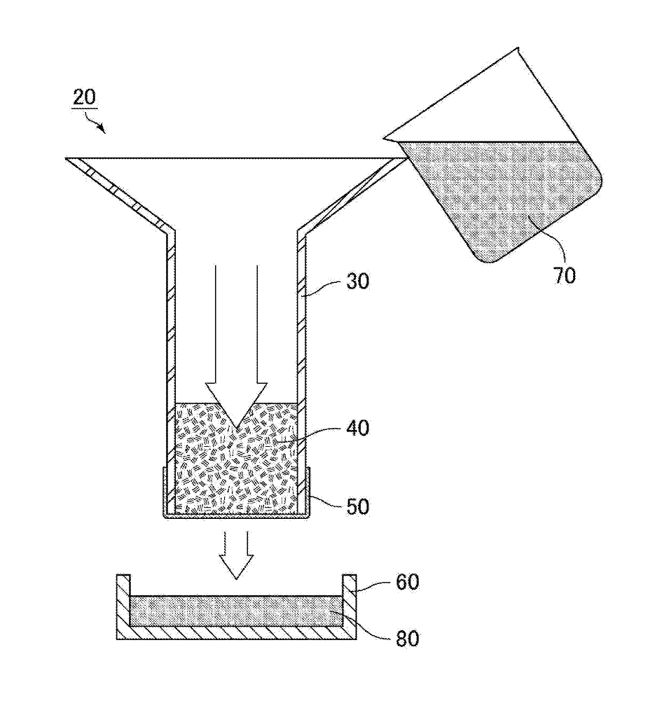

### CROSS REFERENCE TO RELATED APPLICATIONS

The present application is a continuation of International application No. PCT/JP2016/051857, filed Jan. 22, 2016, which claims priority to Japanese Patent Application No. 2015-067164, filed Mar. 27, 2015, the entire contents of each of which are incorporated herein by reference.

### FIELD OF THE INVENTION

The present invention relates to a method of producing a dielectric material.

### BACKGROUND OF THE INVENTION

As a method of producing a dielectric material for forming a dielectric layer in a multilayer ceramic capacitor (hereinafter also described as MLCC), mixing and dispersing various metal compounds in basic powder of, for example, barium titanate, is known. These metal compounds are mixed to improve an electrical property and a sintering property of the dielectric material. The metal compounds include metal carbonates and metal oxides.

In recent years, MLCCs have been miniaturized, and thus it has been desired that the thickness of the dielectric layer is reduced. Therefore, it has been required that the fineness of grains of the dielectric material is increased. However, it is difficult to uniformly disperse the metal compounds in the basic powder in a microscopic level in the case where a small amount of powder of metal compounds is mixed with the basic powder.

Patent Document 1 discloses a technique of uniformly dispersing added metal elements in basic powder by mixing a hydrophobic metal salt, a silane coupling agent serving as a silicon compound, and the basic powder in an organic solvent.

Patent Document 2 discloses a technique of producing dielectric material powder by preparing an aqueous slurry by using a silica sol as a silicon compound.
Patent Document 1: Japanese Patent Application Laid-Open No. 4-338152
Patent Document 2: Japanese Patent Application Laid-Open No. 2003-176180

### SUMMARY OF THE INVENTION

In the technique disclosed in Patent Document 1, since an organic solvent is used, an explosion-proof apparatus or an explosion-proof facility is needed for production of a dielectric material, and thus it is difficult to keep the cost for production low.

In addition, Si alkoxide, such as tetraethoxysilane (TEOS) used as a silane coupling agent, that is inexpensive and soluble in an organic solvent volatilizes when being dried, and thus it is needed to add organic matter for stabilizing the Si alkoxide as a sol.

If the organic matter is added, problems such as a problem in a molded body caused by a reaction with a binder for molding and occurrence of a crack in a sintered body caused by decomposition of the organic matter arise when molding and firing the powder including the organic matter, and thus a heat treatment process for decomposing and removing the organic matter in the dielectric material powder is typically provided before performing the molding. There is a problem that, for example, sintering is promoted by heat generated by the decomposition of the organic matter during this heat treatment, and thus large grains become more likely to be generated and dispersion of dielectric material grains of a product deteriorates.

In Patent Document 2, a silica sol is used as the silicon compound. The grain diameter of the silica sol is typically about 5 nm to 20 nm, and the silica sol takes a stably dispersed state only in a certain pH range. Therefore, there is a problem that agglomeration of silicon compound occurs at the time of addition of various metal salts and thus it is difficult to form microscopically uniform coating.

In addition, a large amount of various kinds of organic matter is contained for stabilization of the silica sol. Therefore, there is a problem that, for example, sintering is promoted by heat generated by the decomposition of the organic matter during heat treatment, and thus large grains become more likely to be generated and dispersion of dielectric material grains of a product deteriorates.

The present invention was made to solve the problems described above, and an object thereof is to provide a method of producing, by using an aqueous slurry, a dielectric material in which metal elements and a Si component are uniformly distributed on the surface of dielectric powder, in which abnormal generation of heat is not likely to be caused by heat treatment, and which can suppress inter-grain sintering caused by the abnormal generation of heat.

A method of producing a dielectric material of the present invention includes preparing a slurry by mixing a dielectric powder, water, one of an organic-acid metal salt and an inorganic metal salt, and an organic silicon compound, the organic-acid metal salt being a metal salt of at least one kind of organic acid selected from a group consisting of monocarboxylic acids, dicarboxylic acids, polyvalent carboxylic acids of trivalent or more, and hydroxy carboxylic acids each having 6 or less carbon atoms, causing the slurry to come into contact with an anion exchange resin to remove an anion derived from the one of the organic-acid metal salt and the inorganic metal salt from the slurry, and drying the slurry to obtain the dielectric material.

According to the method of producing a dielectric material of the present invention, necessity of organic solvent is eliminated as much as possible, and thus an explosion-proof apparatus and an explosion-proof facility are not needed and a dielectric material can be produced safely at low production cost. To be noted, one of an organic solvent and a solvent in which a small amount of organic matter is mixed in a slurry for surface activity may be used as long as an explosion-proof apparatus or an explosion-proof facility is not required.

In addition, since one of an organic-acid metal salt soluble in water and an inorganic metal salt is used for preparation of a slurry, a metal element can be dissolved in an aqueous slurry in a form of a metal ion. Therefore, metal elements can be more uniformly distributed on the surface of particles of dielectric powder, and thus a highly reliable dielectric material that has a uniform characteristic can be produced.

In addition, an organic silicon compound is used as the silicon compound. Examples of the organic silicon compound include alkoxysilane and aqueous silane coupling agents. The alkoxysilane is not likely to be dissolved in water as it is. However, the alkoxysilane can be imparted with water-solubility by coexisting with, for example, an organic acid salt, and the water-soluble silane coupling agent dissolves in water. Therefore, the silicon compound can be dispersed in the aqueous slurry in a molecular level.

In addition, according to the present invention, organic-acid anions or anions derived from the inorganic metal salt contained in the slurry can be exchanged with OH⁻ ions in an anion removing step by bringing an anion exchange resin into contact with the slurry, and thus a slurry whose content of anion derived from one of the organic-acid metal salt and the inorganic metal salt is greatly reduced can be prepared.

Accordingly, by drying the slurry after the anion removing step, the metal elements and Si component can be uniformly distributed on the surface of the dielectric powder, and a dielectric material in which the amount of organic acid and the like adsorbed on the surface thereof is greatly reduced can be produced. In addition, an amorphous film in which the metal elements and Si component are uniformly distributed is formed on the surface of the dielectric material after the drying and heat treatment. By using this material, metal elements can be uniformly allowed to form a solid solution in crystal grains constituting the dielectric powder in a short period of time at the time of sintering in a production process of a multilayer ceramic capacitor. In addition, since the amount of organic acid and the like adsorbed on the surface of the dielectric powder before heat treatment is greatly reduced, abnormal heat generation caused by the organic acid and the like is not likely to occur at the time of heat treatment, and thus inter-grain sintering caused by the abnormal heat generation can be suppressed and a highly-dispersed raw material for a multilayer ceramic capacitor can be prepared.

As a result of this, a multilayer ceramic capacitor with a high reliability and little scattering of withstand voltage property can be obtained by using the dielectric material of the present invention.

In the method of producing a dielectric material of the present invention, it is preferable that the organic silicon compound is an alkoxysilane represented by a general formula (1) below.

Si—(OR)₄ (1)

(In the general formula (1), R represents one of a methyl group and an ethyl group, and four Rs may be the same or different groups.)

In the case where the alkoxysilane represented by the general formula (1) above is used as the organic silicon compound in the preparation step of the method of producing a dielectric material of the present invention, the organic-acid metal salt can use organic-acid ions electrolytically dissociated in the slurry as a catalyst, and thus hydrolysis of the alkoxysilane is promoted, and water-solubility is imparted. According to this, the alkoxysilane can be dispersed in an aqueous slurry as a silicon compound at a molecular level, and the effects described above can be achieved.

In the case where the alkoxysilane represented by the general formula (1) is used as the organic silicon compound, it is preferable that the slurry is prepared as an alkaline slurry.

In the case where an alkaline slurry is used, hydrolysis of the alkoxysilane is promoted, and thus the processing time for hydrolyzing the alkoxysilane is reduced and the efficiency of production of a dielectric material can be improved.

In the case where the alkoxysilane represented by the general formula (1) above is used as the organic silicon compound, it is preferable that an alkaline alkoxysilane solution is prepared by mixing the alkoxysilane and an alkaline aqueous solution, and the alkaline slurry is prepared by mixing the alkaline alkoxysilane solution with the dielectric powder, the water, and the one of the organic-acid metal salt and the inorganic metal salt.

As a method of preparing the alkaline slurry, the alkoxysilane and the alkaline aqueous solution are mixed in advance, and hydrolysis of the alkoxysilane is caused to progress. In this case, processing time for obtaining an aqueous slurry by mixing the alkaline slurry with the dielectric powder, the water, the one of the organic-acid metal salt and the inorganic metal salt.

In addition, in the case where the alkoxysilane represented by the general formula (1) above is used as the organic silicon compound, it is preferable that a slurry is prepared by mixing the dielectric powder, the water, and the one of the organic-acid metal salt and the inorganic metal salt, and the alkoxysilane, and the alkaline slurry is prepared by further adding an alkaline aqueous solution thereto.

As a method of preparing the alkaline slurry, hydrolysis of the alkoxysilane can be caused to progress by adding the alkaline aqueous solution also in the case where the alkaline aqueous solution is added after mixing the dielectric powder, the water, the one of the organic-acid metal salt and the inorganic metal salt, and the alkoxysilane, and thus the processing time for obtaining an aqueous slurry can be shortened.

In the method of producing a dielectric material of the present invention, it is preferable that the organic silicon compound is a water-soluble silane coupling agent.

In the case where the a water-soluble silane coupling agent is used as the organic silicon compound, since the water-soluble silane coupling agent can dissolve in water, the silicon compound can be dispersed in an aqueous slurry in a molecular level. Accordingly, the effect described above can be achieved.

In the method of producing a dielectric material of the present invention, it is preferable that the water-soluble silane coupling agent includes one of an amino group and a carboxy group as a water-soluble functional group.

The water-soluble silane coupling agent including one of an amino group and a carboxy group is particularly excellent in water solubility, and thus an aqueous slurry in which a silicon compound is uniformly dissolved can be prepared easily.

In the method of producing a dielectric material of the present invention, it is preferable that the drying in the drying step is performed via spray drying.

By performing the drying via spray drying, segregation of the metal components and Si component between particles of the dielectric powder at the time of drying can be suppressed.

In the method of producing a dielectric material of the present invention, it is preferable that the dielectric powder is one of barium titanate powder and barium titanate-based powder in which part of the barium in barium titanate is substituted by calcium.

A dielectric material formed from such dielectric powder can be preferably used for forming a dielectric layer of a multilayer ceramic capacitor.

In the method of producing a dielectric material of the present invention, it is preferable that a metal element included in the one of the organic-acid metal salt and the inorganic metal salt is at least one of Dy, Gd, Y, Mn, Mg, Sr, Nb, Nd, V, Co, Ni, Ce, Er, Ca, Ba, and Li.

By adding these metal elements as additives, the electrical property and sintering property of the dielectric material is improved.

In the method of producing a dielectric material of the present invention, it is preferable that the organic acid is acetic acid.

Metal acetate generally has a high solubility in water, and is thus suitable as a raw material for dissolving metal elements in an aqueous slurry.

According to the present invention, an aqueous slurry in which metal elements serving as additives and an organic silicon compound as a silicon compound are dissolved together can be prepared, organic anions derived from organic acid or anions derived from an inorganic acid salt can be removed by ion exchange, and thus, after drying, metal elements and a Si component are uniformly distributed on the surface of dielectric powder, and the amount of anions derived from organic acid adsorbed on the surface of the dielectric powder or from an inorganic metal salt is greatly reduced.

As a result of this, a raw material for a multilayer ceramic capacitor in which abnormal heat generation is not likely to occur and inter-grain sintering caused by abnormal heat generation can be suppressed and which is highly dispersed can be provided.

Accordingly, a multilayer ceramic capacitor with a high reliability and little scattering of withstand voltage property can be obtained by using the dielectric material of the present invention.

### BRIEF EXPLANATION OF THE DRAWING

The FIGURE is a diagram schematically illustrating an example of an anion removing step using an anion exchange resin.

### DETAILED DESCRIPTION OF THE INVENTION

A method of producing a dielectric material of the present invention will be described below.

However, the present invention is not limited to the configurations below, and modification can be appropriately made in a range not changing the scope of the present invention.

Embodiments shown below are merely examples, and it goes without saying that configurations shown in different embodiments may be partially replaced and combined.

Combinations of two or more of individual preferable configurations of the present invention that will be described below also correspond to the present invention.

A method of producing a dielectric material of the present invention is characterized as including a step of preparing a slurry by mixing dielectric powder, water, one of an organic-acid metal salt and an inorganic metal salt, and an organic silicon compound, the organic-acid metal salt being a metal salt of at least one kind of organic acid selected from a group consisting of monocarboxylic acids, dicarboxylic acids, polyvalent carboxylic acids of trivalent or more, and hydroxy carboxylic acids each having 6 or less carbon atoms, a step of causing the slurry to come into contact with an anion exchange resin to remove, from the slurry, an anion derived from the one of the organic-acid metal salt and the inorganic metal salt, and a drying step of drying the slurry to obtain a dielectric material.

An organic silicon compound is used in a slurry preparation step of the present invention. Although the kind of the organic silicon compound is not particularly limited, the organic silicon compound is preferably, for example, represented by a general formula (2) below.

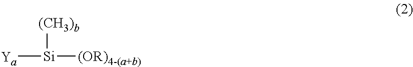

(In the general formula (2), R represents one of a methyl group and an ethyl group; Y represents a water-soluble functional group; a and b each represent 0 or 1; and a plurality of Rs may be the same or different.)

Examples of the organic silicon compound represented by the general formula (2) include alkoxysilanes represented by a general formula (1) below

Si—(OR)₄ (1)

(in the general formula (1), R represents one of a methyl group and an ethyl group, and four Rs may be the same or different groups)

and water-soluble silane coupling agents.

A case where an alkoxysilane is used as the organic silicon compound and a case where a water-soluble silane coupling agent is used as the organic silicon compound will be respectively described below.

### 1. First Exemplary Embodiment (Method of Producing Dielectric Material Using Alkoxysilane as Organic Silicon Compound)

In a first exemplary embodiment, a method of producing a dielectric material in the case of using an alkoxysilane as an organic silicon compound will be described.

(1) Preparation Step of Preparing Slurry

First, a slurry is prepared by mixing dielectric powder, water, one of an organic-acid metal salt and an inorganic metal salt, and alkoxysilane.

Powder of a perovskite-type compound including Ba and Ti is preferable as the dielectric powder. Specific examples of the perovskite-type compound include perovskite-type compounds represented by a general formula ABO₃ (A sites correspond to Ba and may include at least one selected from a group consisting of Sr and Ca in addition to Ba; B sites correspond to Ti and may include at least one selected from a group consisting of Zr and Hf in addition to Ti; and O corresponds to oxygen).

In addition, preferable examples of the perovskite-type compound include barium titanate (that is, BaTiO₃), and barium titanate-based compounds obtained by partially substituting barium in barium titanate (BaTiO₃) by calcium.

It is preferable that the average particle diameter of the dielectric powder is 20 nm to 300 nm (inclusive).

According to the method of the present exemplary embodiment, metal elements and a Si component can be uniformly distributed on even the surface of such dielectric powder having a small particle diameter.

According to a conventional method, it is difficult to uniformly distribute metal elements and a Si component on the surface of such a dielectric powder having a small particle diameter.

Distilled water, deionized water, pure water, ultrapure water, or the like is preferably used as the water.

A water-soluble metal salt is preferably used as the organic-acid metal salt. In this description, “water-soluble” means having solubility sufficient for an organic-acid metal salt corresponding to the amount of metal elements added as additives to dissolve in water.

The amount of metal elements added to the dielectric powder is normally very small, and thus the value of the solubility of the organic-acid metal salt does not need to be very high. Therefore, even an organic-acid metal salt that is classified as a “poorly soluble salt” in normal definition can be used as the “water-soluble” organic-acid metal salt of the present description in some cases.

Examples of the organic-acid metal salt include metal salts of at least one kind of organic acid selected from a group consisting of monocarboxylic acids, dicarboxylic acids, polyvalent carboxylic acids of trivalent or more, and hydroxy carboxylic acids each having 6 or less carbon atoms.

A single kind of organic-acid metal salt may be used, and a plurality of kinds of organic-acid metal salts may be used in combination. For example, two or more kinds of metal salts of monocarboxylic acids having 6 or less carbon atoms may be used in combination, and a metal salt of monocarboxylic acid having 6 or less carbon atoms may be used in combination with a metal salt of hydroxy carboxylic acid having 6 or less carbon atoms.

In addition, when using two or more kinds of organic-acid metal salts in combination, two or more kinds of organic-acid metal salts whose organic acids are of different kinds and whose metals are of the same kind may be used in combination, and two or more kinds of organic-acid metal salts whose organic acids are of the same kind and whose metals are of different kinds may be used in combination.

Organic acids shown below are preferable as the organic acid.

As the monocarboxylic acid having 6 or less carbon atoms, formic acid, acetic acid, and propionic acid are preferable, and acetic acid is more preferable.

As the dicarboxylic acid, dicarboxylic acids having 6 or less carbon atoms are preferable, and oxalic acid, malonic acid, succinic acid, fumaric acid, maleic acid, and glutaric acid are more preferable. As the polyvalent carboxylic acid, polyvalent carboxylic acids having 6 or less carbon atoms are preferable.

As the hydroxy carboxylic acid, hydroxy carboxylic acids having 6 or less carbon atoms are preferable, and lactic acid, citric acid, malic acid, tartaric acid, and gluconic acid are more preferable.

In addition, among the hydroxy carboxylic acids described above, hydroxy carboxylic acids having one carboxylic group (lactic acid and gluconic acid) can be also regarded as monocarboxylic acids having 6 or less carbon atoms, hydroxy carboxylic acids having two carboxylic groups (malic acid and tartaric acid) can be also regarded as dicarboxylic acids, and hydroxy carboxylic acids having three or more carboxylic groups (citric acid) can be also regarded as polyvalent carboxylic acids.

As the metal element included in the organic-acid metal salt, at least one of Dy, Gd, Y, Mn, Mg, Sr, Nb, Nd, V, Co, Ni, Ce, Er, Ca, Ba, and Li is preferable. By adding these metal elements as additives, the electrical property and sintering property of the dielectric material is improved.

Among these, at least one of Dy, Mn, and Mg is more preferable.

In addition, as the combination of organic acid and metal element included in the organic-acid metal salt, any combination of the organic acids and the metal elements described above is possible. Examples of preferable combinations include dysprosium acetate, manganese acetate, and magnesium acetate.

A water-soluble metal salt is used as the inorganic metal salt. In this description, “water-soluble” means having solubility sufficient for an inorganic metal salt corresponding to the amount of metal elements added as additives to dissolve in water similarly to the case of organic-acid metal salt. Examples of the inorganic metal salt include metal chlorides, metal nitrates, metal sulfates, and metal carbonates.

As the metal element included in the inorganic metal salt, at least one of Dy, Gd, Y, Mn, Mg, Sr, Nb, Nd, V, Co, Ni, Ce, Er, Ca, Ba, and Li is preferable. By adding these metal elements as additives, the electrical property and sintering property of the dielectric material is improved. Among these, at least one of Dy, Mn, and Mg is more preferable.

Alkoxysilane serving as the silicon compound includes four alkoxy groups. Alkoxysilane is represented by the general formula (1).

Si—(OR)₄ (1)

(In the general formula (1), R represents one of a methyl group and an ethyl group, and four Rs may be the same or different groups.)

Examples of preferable alkoxysilane include tetraethoxysilane (TEOS) in which the four Rs are all ethyl groups and tetramethoxysilane (TMOS) in which the four Rs are all methyl groups, and tetraethoxysilane (TEOS) is more preferable.

Although these alkoxysilanes do not dissolve in water as they are, silicon compounds obtained by hydrolyzing at least one of the four alkoxy groups can dissolve in water.

The silicon compounds obtained by hydrolyzing at least one of the four alkoxy groups of the alkoxysilane are represented by a general formula (3) below.

(HO)ₙ—Si—(OR)₄₋ₙ (3)

In the general formula (3), n represents an integer from 1 to 4 (inclusive). R represents one of a methyl group and an ethyl group. In the case where n is 1 or 2, the silicon compound includes a plurality of Rs. In this case, the Rs may be the same or different. Further, the number n of hydrolyzed alkoxy groups does not need to be entirely the same, and n may be different.

Since the speed of hydrolysis of alkoxy groups is slow in a neutral region, the aqueous slurry is preferably an alkaline slurry.

In the case where an alkaline slurry is used, the hydrolysis of alkoxysilane is promoted, and thus the processing time for hydrolyzing alkoxysilane is reduced and the efficiency of production of the dielectric material can be improved.

To promote the hydrolysis of alkoxysilane, the pH of the slurry is preferably set to 10 to 13 (inclusive).

The pH being in the range described above is preferable because the hydrolysis is promoted, a condensation reaction does not progress so much, and thus SiO₂ grains are not likely to precipitate.

The method of preparing an alkaline slurry is not particularly limited as long as dielectric powder, water, one of an organic-acid metal salt and an inorganic metal salt, an alkoxysilane, and an alkaline component can be mixed by the method, and the order of mixing of each component is not particularly limited either.

An alkaline solution can be used as the alkaline component, and ammonia water can be preferably used.

In the case of using ammonia water, since ammonia volatilizes easily, the alkaline component remaining in the dielectric material and degrading the properties of the dielectric material can be suppressed. In addition, in the case of using ammonia water, heat is less likely to be generated at the time of firing, sintering of grains caused by local heat generation can be suppressed, and powder of a dielectric material that does not include many coarse grains and has a small average grain diameter can be obtained.

Specific examples of the method of preparing an alkaline slurry include a method (alkaline slurry preparation method 1) of preparing an alkaline slurry by mixing an alkoxysilane and an alkaline aqueous solution to prepare an alkaline alkoxysilane solution and mixing the alkaline alkoxysilane solution with dielectric powder, water, and one of an organic-acid metal salt and an inorganic metal salt.

In addition, the examples also include a method (alkaline slurry preparation method 2) of preparing an alkaline slurry by mixing dielectric powder, water, one of an organic-acid metal salt and an inorganic metal salt, and an alkoxysilane to prepare a slurry, and further adding an alkaline aqueous solution to prepare an alkaline slurry.

The hydrolysis of alkoxysilane can be promoted by adding an alkaline aqueous solution, and thus processing time for preparing an aqueous slurry can be shortened according to either one of the alkaline slurry preparation methods 1 and 2.

In the alkaline slurry preparation method 1, holding time after preparing the alkaline alkoxysilane solution by mixing an alkoxysilane with an alkaline aqueous solution and before mixing other components is preferably 20 minutes or shorter and more preferably 10 minutes or shorter.

In the case where the holding time is 20 minutes or shorter, occurrence of condensation reaction following the hydrolysis can be prevented, and the slurry becoming clouded can be suppressed.

(2) Anion Removing Step

In the anion removing step, the slurry is brought into contact with an anion exchange resin to remove anions derived from the one of the organic-acid metal salt and the inorganic metal salt contained in the slurry.

As the anion exchange resin, a known anion exchange resin that is used for removing organic-acid anions and the like can be used, and an anion exchange resin including amino groups or imino groups (for example, DIAION (registered trademark) SA10A-OH type available from Mitsubishi Chemical Corporation) can be used.

The FIGURE schematically illustrates an example of an anion removing step using an anion exchange resin.

In the anion removing step using an anion exchange resin, an anion removing apparatus 20 in which one end of a plastic cylinder 30 is covered by a mesh (#100) 50 such that an anion exchange resin does not fall off and then an anion exchange resin 40 is injected, as illustrated in the FIGURE, can be used.

In the anion removing step, a slurry 70 prepared in the (1) slurry preparation step is put in the anion removing apparatus 20. Then, the slurry 70 is caused to pass through the anion exchange resin 40 to remove organic-acid anions or anions derived from the inorganic metal salt via ion exchange, and a slurry 80 after removing the organic acid and the like is discharged through the mesh 50 and collected on a receiving stage 60.

According to the step described above, a slurry whose content of anions derived from one of an organic acid and an inorganic metal salt is greatly reduced can be obtained.

(3) Drying Step

In the drying step, the slurry after anion removal is dried to obtain a dielectric material.

A silicon compound obtained by hydrolyzing the alkoxysilane contained in the slurry is uniformly adsorbed on the surface of the dielectric powder dried in the drying step, and the amount of anions derived from the one of the organic acid and the inorganic metal salt and adsorbed on the surface of the dielectric powder is greatly reduced.

By drying this dielectric powder, a dielectric material in which metal elements and a Si component are uniformly distributed on the surface of dielectric powder can be produced.

In addition, although the method of drying in the drying step is not particularly limited, drying using a rotary evaporator or the like that dries the slurry while stirring the slurry, thin film drying using a drum drier or the like that dries instantly, and spray drying such as fine droplet drying are preferable. Among these, spray drying is more preferable.

In addition, in the case of drying while heating, a drying temperature is preferably 40° C. to 250° C. (inclusive).

By undergoing the step described above, a dielectric material suitable for raw material powder of a dielectric layer in a multilayer ceramic capacitor can be produced.

To be noted, the obtained material may be used as it is for production of the multilayer ceramic capacitor or the like after the drying step, and may be used for production of the multilayer ceramic capacitor or the like after being subjected to heat treatment at a temperature of about 350° C. to 500° C. (inclusive) to remove a small amount of remaining organic acid.

### 2. Second Exemplary Embodiment (Method of Producing Dielectric Material Using Water-Soluble Silane Coupling Agent as Organic Silicon Compound)

Next, as a second exemplary embodiment, a method of producing a dielectric material in the case of using a water-soluble silane coupling agent as an organic silicon compound will be described. Whereas an alkoxysilane is used as the organic silicon compound in the first exemplary embodiment, in the second exemplary embodiment, contrary to the first exemplary embodiment, a water-soluble silane coupling agent is used as the organic silicon compound.

(1) Preparation Step of Preparing Slurry

First, a slurry is prepared by mixing dielectric powder, water, one of an organic-acid metal salt and an inorganic metal salt, and a water-soluble silane coupling agent.

Since the dielectric powder, water, and one of organic-acid metal salt and inorganic metal salt that are used have been described in the first exemplary embodiment, the description thereof will be omitted herein.

The water-soluble silane coupling agent preferably has a structure represented by a general formula (4).

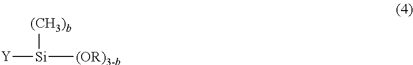

(In the general formula (4), Y represents a water-soluble functional group; b represents 0 or 1; R represents one of a methyl group and an ethyl group; and two or three plural Rs may be the same or different.)

In addition, the water-soluble silane coupling agent preferably has a structure represented by one of general formulae (5), (6), and (7) below.

The water-soluble silane coupling agent having a structure represented by one of general formulae (5), (6), and (7) has an oligomerized structure as a result of a silane coupling agent being partially hydrolyzed or a condensation reaction having progressed.

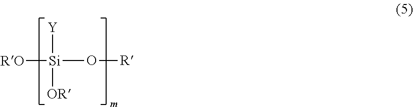

(In the general formula (5), Y represents a water-soluble functional group; m represents an integer of 2 or more; R′ represents one of a hydrogen atom, a methyl group, and an ethyl group; and a plurality of Ys and R′s may be the same or different.)

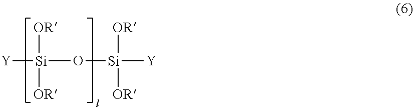

(In the general formula (6), Y represents a water-soluble functional group; l represents an integer of 1 or more; R′ represents one of a hydrogen atom, a methyl group, and an ethyl group; and a plurality of Ys and R′s may be the same or different.)

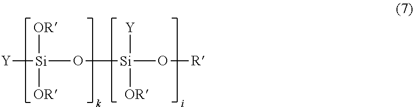

(In the general formula (7), Y represents a water-soluble functional group; k and i each represent an integer of 1 or more; R′ represents one of a hydrogen atom, a methyl group, and an ethyl group; and a plurality of Ys and R′s may be the same or different.)

With regard to the water-soluble silane coupling agent having a structure represented by one of the general formulae (5), (6), and (7), the ratio of R′s present in the silane coupling agent as hydrogen atoms being high means that many alkoxy groups have been hydrolyzed and turned into hydroxyl groups. A large part of the structure of the silane coupling agent having been hydrolyzed is preferable because this makes it easier for the silane coupling agent to dissolve in water. In addition, a structure in which all the R′s are hydrogen atoms is particularly preferable.

Water-soluble silane coupling agents represented by the general formula (4), (5), (6), and (7) have a water-soluble functional group and thus easily dissolve in water. Further, the water-soluble functional group functions as a catalyst that promotes hydrolysis of alkoxy groups (OR in the general formula (4) or OR′ of the general formulae (5), (6), and (7) in the case where R′ is one of a methyl group and an ethyl group) included in the water-soluble silane coupling agents, and thus the hydrolysis progresses quickly. In addition, as a result of hydroxyl groups generated by hydrolysis adsorbing on the surface of the dielectric powder via hydrogen bonding, a state in which the water-soluble silane coupling agent is uniformly dispersed on the surface of the dielectric powder can be achieved.

Preferable examples of the water-soluble functional group include a group including at least one functional group selected from a group consisting of an amino group, an epoxy group, a mercapto group, a sulfide group, a (meth)acrylic group, and a carboxy group.

It is also preferable that the water-soluble functional group is one of an amino group, an epoxy group, a mercapto group, a sulfide group, a (meth)acrylic group, and a carboxy group itself.

In addition, it is also preferable that the water-soluble functional group is a group positioned at a terminal end, and, for example, a group including a carboxy group at a terminal end thereof as represented by a general formula (8) below is included in examples of a group including a carboxy group.

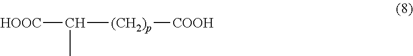

(In the general formula (8), p represents an integer from 1 to 5 (inclusive).)

To be noted, a (meth)acrylic group means one of a methacrylic group and an acrylic group.

In addition, it is more preferable that the water-soluble functional group includes one of an amino group and a carboxy group. This is because the water-soluble silane coupling agent including one of an amino group and a carboxy group is particularly excellent in solubility in water, and thus an aqueous slurry in which a silicon compound is uniformly dispersed can be prepared easily.

In addition, it is further preferable that the water-soluble functional group includes an amino group. Using a water-soluble silane coupling agent including an amino group improves the fluidity of the slurry, and thus is advantageous from the viewpoint of production.

Preferable specific examples of the water-soluble silane coupling agent represented by the general formula (4) above include N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, 3-mercaptopropylmethyldimethoxysilane, 3-mercaptopropyltrimethoxysilane, bis(triethoxysilylpropyl)tetrasulfide, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane.

Among these, N-2-(aminoethyl)-3-aminopropyltrimethoxysilane, 3-aminopropyltrimethoxysilane, and 3-aminopropyltriethoxysilane, in which the water-soluble functional group includes an amino group, are more preferable.

When preparing a slurry by mixing dielectric powder, water, one of an organic-acid metal salt and an inorganic metal salt, and a water-soluble silane coupling agent, the order of the mixing is not particularly limited.

For example, a method of preparing a slurry by mixing and dispersing dielectric powder in a solution in which one of an organic-acid metal salt and an inorganic metal salt is dissolved, and then adding a water-soluble silane coupling agent to the slurry may be used.

(2) The (2) anion removing step and the (3) drying step can be performed in a similar manner to the method of producing a dielectric material of the first exemplary embodiment using an alkoxysilane as the organic silicon compound, and thus detailed descriptions thereof will be omitted herein.

By undergoing the steps described above, a dielectric material suitable for raw material powder of a multilayer ceramic capacitor can be produced.

The dielectric materials produced by the methods of producing a dielectric material of the first exemplary embodiment and the second exemplary embodiment of the present invention described above are suitable for raw material powder of a dielectric layer of a multilayer ceramic capacitor.

In the case of producing a multilayer ceramic capacitor, organic binder, plasticizer, and an organic solvent are added, as necessary, to the dielectric material produced by a method of producing a dielectric material of the present invention, and are then mixed by using, for example, a ball mill, and thus a ceramic slurry is prepared.

Then, production of a ceramic green sheet using the ceramic slurry, formation of a conductive paste film that is to serve as an inner electrode layer, and lamination and firing of ceramic green sheets on which conductive paste films have been formed are performed, and thus a laminate including a dielectric ceramic layer and a plurality of inner electrode layers is obtained.

Finally, external electrodes are formed on both end surfaces of the laminate, and thus a multilayer ceramic capacitor can be produced.

In each of these steps, known techniques and step conditions can be used.

To be noted, a firing condition after lamination of the ceramic green sheets is preferably at a temperature of 1150° C. to 1350° C. (inclusive) and in a reducing atmosphere consisting of H₂—N₂—H₂O gas of a partial oxygen pressure of 10⁻¹² MPa to 10⁻⁹ MPa (inclusive).

In addition, examples of a method of forming external electrodes include a method of applying and forming a conductive paste layer serving as an external electrode before firing of the ceramic green sheet, and sintering the conductive paste layer together at the time of firing of the laminate.

### EXAMPLES

Examples specifically disclosing the method of producing a dielectric material of the present invention will be described below. To be noted, the present invention is not limited to these examples.

### Example 1

In 300 g of water, 1.76 g of dysprosium acetate and 0.53 g of manganese acetate were added, mixed and stirred, and thus an aqueous solution in which dysprosium acetate and manganese acetate were dissolved in water was prepared. To this, 100 g of grains of barium titanate (hereinafter referred to as BT grains) having an average grain diameter of 150 nm were added, and thus a slurry was prepared. To the prepared slurry, 2.1 g of 3-aminopropyltrimethoxysilane was added, stirring was performed for 30 minutes, and thus a slurry was prepared.

Next, an anion removing apparatus 20 as illustrated in the FIGURE was prepared.

That is, one end of a plastic cylinder 30 was covered by a mesh 50 to prevent an anion exchange resin from falling off, and then 200 ml of an anion exchange resin 40 (DIAION (registered trademark) SA10A-OH type available from Mitsubishi Chemical Corporation) was injected.

Next, a prepared slurry 70 was injected in the anion removing apparatus 20 prepared in the way described above through the other end and was caused to pass through the anion exchange resin 40, and a slurry 80 that had passed through the anion exchange resin 40 was collected.

Then, the slurry was dried through evaporation by using a spray drying apparatus and subjected to heat treatment at 500° C.

As a result of performing composition analysis by an ICP emission spectroscopy analysis method, the analyzed amounts of Si, Dy, and Mn matched the amount of respective added elements with differences of 10% or smaller.

The obtained powder was added to an aqueous solution of hexametaphosphoric acid in a rate of 0.6 g/L and dispersed by an ultrasonic disperser of 300 W, and a ratio (coarse grain ratio) of coarse grains having a grain diameter of 1 μm or larger and a ratio (coarse grain ratio) of coarse grains having a grain diameter of 1.2 μm or larger were checked via image analysis using a wet flow grain diameter/shape analysis apparatus. As a result, as shown in Table 1 below, the coarse grain ratio of grain diameter of 1 μm or larger was 0.15%, and the coarse grain ratio of grain diameter of 1.2 μm or larger was 0.01%

In addition to this, comparison was made for dried powder in terms of an electromotive force of a thermocouple between a standard sample and a measurement target sample by using a TG-DTA apparatus to assess the amount of heat generation at the time of heat treatment. A larger electromotive force indicates a larger amount of heat generation, and the heat generating electromotive force at 250° C. to 400° C. of the present example was 5.2 μV as shown in Table 1 below.

### Example 2

In 300 g of water, 1.76 g of dysprosium acetate and 0.53 g of manganese acetate were added, mixed and stirred, and thus an aqueous solution in which dysprosium acetate and manganese acetate were dissolved in water was prepared. To this, 100 g of BT grains having an average grain diameter of 150 nm was added, and thus a slurry was prepared. While stirring the prepared slurry, 1.9 g of tetraethoxysilane (hereinafter referred to as TEOS) was added, stirring was performed for 8 hours, and thus a slurry was prepared.

Next, an anion removing apparatus 20 as illustrated in the FIGURE was prepared.

That is, one end of a plastic cylinder 30 was covered by a mesh 50 to prevent an anion exchange resin from falling off, and then 200 ml of an anion exchange resin 40 (DIAION (registered trademark) SA10A-OH type available from Mitsubishi Chemical Corporation) was injected.

Then, as a result of leaving the slurry to stand, separation of TEOS was not recognized, and the progress of hydrolysis was recognized.

Next, a prepared slurry 70 was injected in the anion removing apparatus 20 prepared in the way described above through the other end and was caused to pass through the anion exchange resin 40, and a slurry 80 that had passed through the anion exchange resin 40 was collected.

Then, the slurry was dried through evaporation by using a spray drying apparatus and subjected to heat treatment at 500° C.

The results of composition analysis performed via an ICP emission spectroscopy analysis method matched the amount of respective added elements with differences of 10% or smaller. The obtained powder was added to an aqueous solution of hexametaphosphoric acid in a rate of 0.6 g/L and dispersed by an ultrasonic disperser of 300 W, and a ratio (coarse grain ratio) of coarse grains having a grain diameter of 1 μm or larger and a ratio (coarse grain ratio) of coarse grains having a grain diameter of 1.2 μm or larger were checked via image analysis using a wet flow grain diameter/shape analysis apparatus. The results are shown in Table 1 below. In addition to this, comparison was made for dried powder in terms of an electromotive force of a thermocouple between a standard sample and a measurement target sample by using a TG-DTA apparatus to assess the amount of heat generation at the time of heat treatment. The results are shown in Table 1 below.

### Comparative Example 1

A solution was prepared by adding 10.5 g of a xylene solution of dysprosium octylate (the concentration of dysprosium in the solution was 7.8 wt %) and 1.55 g of a mineral spirit solution of manganese octylate (the concentration of manganese in the solution was 8.04 wt %) to a mixture solvent of 32 g of ethanol and 128 g of toluene. This solution was stirred after adding 100 g of BT grains having an average grain diameter of 150 nm thereto, and thus a slurry of BT grains was prepared. To the slurry, 1.9 g of TEOS was added, and stirring was performed for 30 minutes. Then, the slurry was dried through evaporation by a rotary evaporator, and then subjected to heat treatment at 500° C.

The obtained powder was added to an aqueous solution of hexametaphosphoric acid in a rate of 0.6 g/L and dispersed by an ultrasonic disperser of 300 W, and a ratio (coarse grain ratio) of coarse grains having a grain diameter of 1 μm or larger and a ratio (coarse grain ratio) of coarse grains having a grain diameter of 1.2 μm or larger were checked via image analysis using a wet flow grain diameter/shape analysis apparatus. The results are shown in Table 1 below. In addition to this, comparison was made for dried powder in terms of an electromotive force of a thermocouple between a standard sample and a measurement target sample by using a TG-DTA apparatus to assess the amount of heat generation at the time of heat treatment. The results are shown in Table 1 below.

### Comparative Example 2

To 300 g of water, 9.59 g of a water-soluble dysprosium sol (the concentration of dysprosium in the sol was 7.22 wt %) and 2.12 g of a water-soluble manganese sol (the concentration of manganese in the sol was 5.52 wt %) were added. The liquid obtained in this way was stirred after adding 100 g of BT grains having an average grain diameter of 150 nm thereto, and thus a slurry of BT grains was prepared. Next, 1.69 g of a silica sol (the concentration of silica in the sol was 30.39 wt % in terms of SiO₂) was added to the slurry, and the slurry was stirred for 30 minutes. Then, the slurry was dried through evaporation by using a spray drying apparatus, and was further subjected to heat treatment at 500° C.

The obtained powder was added to an aqueous solution of hexametaphosphoric acid in a rate of 0.6 g/L and dispersed by an ultrasonic disperser of 300 W, and a ratio (coarse grain ratio) of coarse grains having a grain diameter of 1 μm or larger and a ratio (coarse grain ratio) of coarse grains having a grain diameter of 1.2 μm or larger were checked via image analysis using a wet flow grain diameter/shape analysis apparatus. The results are shown in Table 1 below. In addition to this, comparison was made for dried powder in terms of an electromotive force of a thermocouple between a standard sample and a measurement target sample by using a TG-DTA apparatus to assess the amount of heat generation at the time of heat treatment. The results are shown in Table 1 below.

### Comparative Example 3

In 300 g of water, 1.76 g of dysprosium acetate and 0.53 g of manganese acetate were added, mixed and stirred, and thus an aqueous solution in which dysprosium acetate and manganese acetate were dissolved in water was prepared. To this, 100 g of BT grains having an average grain diameter of 150 nm was added, and thus a slurry was prepared. To the prepared slurry, 2.1 g of 3-aminopropyltrimethoxysilane was added, stirring was performed for 30 minutes, and thus a slurry was prepared.

Then, the slurry was dried through evaporation by using a spray drying apparatus and subjected to heat treatment at 500° C.

The results of composition analysis performed via an ICP emission spectroscopy analysis method matched the amount of respective added elements with differences of 10% or smaller.

The obtained powder was added to an aqueous solution of hexametaphosphoric acid in a rate of 0.6 g/L and dispersed by an ultrasonic disperser of 300 W, and a ratio (coarse grain ratio) of coarse grains having a grain diameter of 1 μm or larger and a ratio (coarse grain ratio) of coarse grains having a grain diameter of 1.2 μm or larger were checked via image analysis using a wet flow grain diameter/shape analysis apparatus. The results are shown in Table 1 below. In addition to this, comparison was made for dried powder in terms of an electromotive force of a thermocouple between a standard sample and a measurement target sample by using a TG-DTA apparatus to assess the amount of heat generation at the time of heat treatment. The results are shown in Table 1 below.

### Comparative Example 4

In 300 g of water, 1.76 g of dysprosium acetate and 0.53 g of manganese acetate were added, mixed and stirred, and thus an aqueous solution in which dysprosium acetate and manganese acetate were dissolved in water was prepared. To this, 100 g of BT grains having an average grain diameter of 150 nm was added, and thus a slurry was prepared. While stirring the prepared slurry, 1.9 g of tetraethoxysilane (TEOS) was added, stirring was performed for 8 hours, and thus a slurry was prepared.

Then, the slurry was dried through evaporation by using a spray drying apparatus and subjected to heat treatment at 500° C.

The results of composition analysis performed via an ICP emission spectroscopy analysis method matched the amount of respective added elements with differences of 10% or smaller.

The obtained powder was added to an aqueous solution of hexametaphosphoric acid in a rate of 0.6 g/L and dispersed by an ultrasonic disperser of 300 W, and a ratio (coarse grain ratio) of coarse grains having a grain diameter of 1 μm or larger and a ratio (coarse grain ratio) of coarse grains having a grain diameter of 1.2 μm or larger were checked via image analysis using a wet flow grain diameter/shape analysis apparatus. The results are shown in Table 1 below. In addition to this, comparison was made for dried powder in terms of an electromotive force of a thermocouple between a standard sample and a measurement target sample by using a TG-DTA apparatus to assess the amount of heat generation at the time of heat treatment. The results are shown in Table 1 below.

TABLE 1

| | | | Heat generating |
|---|---|---|---|
| | Coarse grain | Coarse grain | electromotive |
| | ratio of 1 μm | ratio of 1.2 μm | force |
| | or larger | or larger | (250-400° C.) |
| | (%) | (%) | (μV) |
| Example 1 | 0.15 | 0.01 | 5.2 |
| Example 2 | 0.13 | 0.01 | 1.2 |
| Comparative | 0.25 | 0.10 | 30.6 |
| Example 1 | | | |
| Comparative | 0.24 | 0.04 | 33.1 |
| Example 2 | | | |
| Comparative | 0.16 | 0.05 | 13.1 |
| Example 3 | | | |
| Comparative | 0.16 | 0.02 | 7.5 |
| Example 4 | | | |

In the dielectric powders (dielectric materials) obtained in Examples 1 and 2, the coarse grain ratios of 1 μm or larger were respectively 0.15% and 0.13%, and the coarse grain ratios of 1.2 μm or larger were both 0.01%. These values are small compared with Comparative Examples 1 to 4, and the coarse grain ratios of 1.2 μm or larger were particularly small. In addition, the heat generating electromotive forces at 250° C. to 400° C. were 1.2% to 5.2%, which were much smaller than in Comparative Examples 1 to 4.

It can be considered that this resulted from the fact that organic acid in the slurry was removed by the anion exchange resin in the anion removing step, and thus no abnormal heat generation occurred in the heat treatment step and the inter-grain sintering caused by abnormal heat generation was successfully suppressed.

In contrast, in the dielectric powders (dielectric materials) obtained in Comparative Examples 1 to 4, the coarse grain ratios of 1 μm or larger were 0.16% to 0.25%, and the coarse grain ratios of 1.2 μm or larger were all 0.02% to 0.10%, which are large compared with Examples 1 and 2. In addition, the heat generating electromotive forces at 250° C. to 400° C. were 7.5 μV to 33.1 μV, which are large values.

It can be considered that one cause of this is that no anion removing step was provided, and thus organic matter was adsorbed on the dielectric powder after drying and abnormal heat generation occurred in heat treatment.

### DESCRIPTION OF REFERENCE SYMBOLS

20: anion removing apparatus
30: cylinder
40: anion exchange resin
50: mesh
60: receiving stage
70: slurry before anion removal
80: slurry after anion removal

1. A method of producing a dielectric material, the method comprising:
preparing a slurry by mixing a dielectric powder, water, a metal salt, and an organic silicon compound;
bringing the slurry into contact with an anion exchange resin to remove an anion derived from the metal salt from the slurry; and
drying the slurry to obtain the dielectric material.

2. The method of producing a dielectric material according to claim 1, wherein the metal salt is an organic-acid metal salt.

3. The method of producing a dielectric material according to claim 2, wherein the organic-acid metal salt is of at least one kind of organic acid selected from monocarboxylic acids, dicarboxylic acids, trivalent or greater carboxylic acids, and hydroxy carboxylic acids each having 6 or less carbon atoms.

4. The method of producing a dielectric material according to claim 1, wherein the metal salt is an inorganic metal salt.

5. The method of producing a dielectric material according to claim 4, wherein the inorganic metal salt is a water-soluble metal salt.

6. The method of producing a dielectric material according to claim 4, wherein the inorganic metal salt is selected from metal chlorides, metal nitrates, metal sulfates, and metal carbonates.

7. The method of producing a dielectric material according to claim 1, wherein the organic silicon compound is an alkoxysilane represented by:
Si—(OR)₄
wherein, R represents one of a methyl group and an ethyl group, and each R is a same or different groups.

8. The method of producing a dielectric material according to claim 7, wherein the slurry is an alkaline slurry.

9. The method of producing a dielectric material according to claim 8, wherein the alkaline slurry is prepared by preparing an alkaline alkoxysilane solution by mixing the alkoxysilane and an alkaline aqueous solution, and mixing the alkaline alkoxysilane solution with the dielectric powder, the water, and the metal salt.

10. The method of producing a dielectric material according to claim 8, wherein the alkaline slurry is prepared by mixing the dielectric powder, the water, the metal salt, and the alkoxysilane, and then further adding an alkaline aqueous solution.

11. The method of producing a dielectric material according to claim 1, wherein the organic silicon compound is a water-soluble silane coupling agent.

12. The method of producing a dielectric material according to claim 11, wherein the water-soluble silane coupling agent includes one of an amino group and a carboxy group as a water-soluble functional group.

13. The method of producing a dielectric material according to claim 1, wherein the drying is performed via spray drying.

14. The method of producing a dielectric material according to claim 1, wherein the drying is performed by heating at a temperature between 40° C. and 250° C.

15. The method of producing a dielectric material according to claim 1, wherein the dielectric powder is one of barium titanate powder and barium titanate-based powder in which part of the barium in the barium titanate is substituted by calcium.

16. The method of producing a dielectric material according to claim 1, wherein a metal element included in the metal salt is at least one of Dy, Gd, Y, Mn, Mg, Sr, Nb, Nd, V, Co, Ni, Ce, Er, Ca, Ba, and Li.

17. The method of producing a dielectric material according to claim 1, wherein the organic acid is acetic acid.

18. The method of producing a dielectric material according claim 1, wherein the dielectric powder has an average particle diameter of 20 nm to 300 nm.
